(19) United States
(12) Patent Application Publication
(10) Pub. No.: US 2026/0328124 A1
(43) Pub. Date: Oct. 22, 2026

(54) BLOW-BY GAS TREATMENT DEVICE AND ENGINE PROVIDED WITH BLOW-BY GAS TREATMENT DEVICE

(71) Applicant: KUBOTA CORPORATION, Osaka-shi, Osaka (JP)

(72) Inventors: Tomohiro SUZUKI, Sakai-shi, Osaka (JP); Yu SUZUKI, Sakai-shi, Osaka (JP)

(21) Appl. No.: 19/104,744

(22) PCT Filed: Aug. 29, 2023
(86) PCT No.: PCT/JP2023/031199

§ 371 Date: Feb. 19, 2025

(30) Foreign Application Priority Data
Nov. 30, 2022 (JP) 2022-191149

(51) Int. Cl. F01M 13/04

(52) U.S. Cl. CPC F01M 13/04; F01M 2013/0472

(57) ABSTRACT

A blow-by gas treatment device is provided, which is capable of more reliably suppressing water vapor that is contained in a gas separated from a blow-by gas being frozen or condensed, and an engine including the blow-by gas treatment device. The blow-by gas treatment device includes a mixing joint having a main pipe into which a new intake is introduced and a sub pipe that introduces a gas, obtained by separating the blow-by gas into an oil and the gas, into the main pipe, and a heating device that is provided in the sub pipe of the mixing joint, wherein the heating device has a heat storage portion that is provided near a connection position connecting with the main pipe in the sub pipe and an electric heater that is provided in the heat storage portion.

### TECHNICAL FIELD

The present invention relates to blow-by gas treatment device that is mounted in an internal combustion engine, such as a diesel engine, and separates a blow-by gas into an oil and a gas to supply the gas to an intake system of the engine, and an engine provided with a blow-by gas treatment device.

### Background Art

A blow-by gas treatment device that separates a blow-by gas that is generated in an engine into an oil and a gas, such as an unburned gas and supplies the gas separated from the blow-by gas to an intake system of the engine is provided in, for example, a head cover of a diesel engine. The gas separated from the blow-by gas is sent to a mixing joint through a pipe and mixed with a new intake in the mixing joint. After that, the gas and the new intake that have been mixed with each other are supplied to the intake system of the engine.

This kind of mixing joint is provided not inside the head cover of the engine but provided in a state of being exposed to the outside of the engine. Incidentally, the gas separated from the blow-by gas contains water vapor. Therefore, when the engine is placed in a low-temperature state, the water vapor that is contained in the gas separated from the blow-by gas may be frozen or condensed in the mixing joint.

In such a case, there is a concern that a gas channel from the mixing joint through the intake system of the engine may be blocked by frozen or condensed moisture. When the gas channel is blocked, the internal pressure of the engine increases, and there is a concern that, for example, an oil seal provided in a crankcase may be damaged or rolled up and oil leakage may occur. In addition, when the gas channel is blocked, the internal pressure of the engine increases, and there is a concern that an oil gauge may fall out from an oil gauge guide and oil leakage may occur. Furthermore, when the gas channel is blocked, the internal pressure of the engine increases, and there is a concern that a turbocharger may absorb oil from the inside of the head cover.

In contrast, PTL 1 discloses a gas reflux device equipped with a warming mechanism. The warming mechanism described in PTL 1 has a conduit that allows cooling water of an engine to pass therethrough, and is capable of warming a reflux passage portion where a blow-by gas passage is connected to an intake passage. The blow-by gas reflux device described in PTL 1 is capable of warming the reflux passage portion with the cooling water of the engine that passes through the warming mechanism even when cooled down in a state of being exposed to the outside in extreme cold, and is thus capable of suppressing moisture in a blow-by gas from being frozen.

### CITATION LIST

### Patent Literature

PTL 1: Japanese Patent Application Publication No. 2020-97910

### SUMMARY OF INVENTION

### Technical Problem

However, the warming mechanism of the blow-by gas reflux device described in PTL 1 is in a state of being exposed to the outside on the engine. The cooling water that passes through the warming mechanism is directly exposed to a cooling air that is generated by a cooling fan of the engine. Therefore, the temperature of the cooling water lowers.

As described above, there is a room for improvement in terms of more reliably suppressing moisture in the blow-by gas from being frozen or condensed in the blow-by gas treatment device.

The present invention has been made in consideration of the above-described circumstance, and an object of the present invention is to provide a blow-by gas treatment device capable of more reliably suppressing water vapor that is contained in a gas separated from a blow-by gas from being frozen or condensed, and an engine including the blow-by gas treatment device.

### Solution to Problem

A first aspect of the present invention is a blow-by gas treatment device treating a blow-by gas that is generated in an engine, the device including a mixing joint having a main pipe into which a new intake is introduced and a sub pipe that introduces a gas, obtained by separating the blow-by gas into an oil and the gas, into the main pipe, and a heating device that is provided in the sub pipe of the mixing joint, wherein the heating device has a heat storage portion that is provided near a connection position connecting with the main pipe in the sub pipe and an electric heater that is provided in the heat storage portion.

According to the first aspect of the present invention, since the heat storage portion is provided near the connection position connecting with the main pipe in the sub pipe, it is possible to store heat generated by the electric heater in the heat storage portion and to efficiently conduct the heat from the heat storage portion to the connection position between the sub pipe and the main pipe. This heat makes it possible to more reliably suppress water vapor that is contained in a gas in the mixing joint being frozen or condensed.

A second aspect of the present invention is the blow-by gas treatment device according to the first aspect of the present invention, wherein the sub pipe has a gradual increase part that gradually increases in thickness thereof from a far position toward a close position relative to the connection position, and the heat storage portion includes at least a part of the gradual increase part.

According to the second aspect of the present invention, since at least a part of the thickness gradual increase part in the sub pipe is used as the heat storage portion, it is possible to store heat from the electric heater in the gradual increase part and efficiently conduct the heat to the connection position between the sub pipe and the main pipe.

A third aspect of the present invention is the blow-by gas treatment device according to the first or second aspect of the present invention, wherein the heat storage portion has a first part that is in contact with an outer surface of the sub pipe and a second part that extends from the first part up to an outer surface of the main pipe.

According to the third aspect of the present invention, since the heat storage part is provided from the part in contact with the outer surface of the sub pipe (first part) up to the outer surface of the main pipe (second part), it is possible to conduct the stored heat to the sub pipe by the first part and conduct the stored heat to the main pipe by the second part.

A fourth aspect of the present invention is the blow-by gas treatment device according to the third aspect of the present invention, wherein the second part is in contact with at least half of a circumference of the outer surface of the main pipe in an extension direction of the main pipe.

According to the fourth aspect of the present invention, since the second part is provided to be in contact with at least half of the circumference of the outer surface of the main pipe, it is possible to efficiently conduct the heat generated by the electric heater from the second part to the main pipe.

A fifth aspect of the present invention is the blow-by gas treatment device according to the third aspect of the present invention, wherein the first part has a flat first surface, and the electric heater is installed on the first surface.

According to the fifth aspect of the present invention, the electric heater is surface-connected to the flat first surface of the first part, whereby it is possible to efficiently conduct the heat generated by the electric heater to the first part.

A sixth aspect of the present invention is the blow-by gas treatment device according to the third aspect of the present invention, wherein the first part and the second part are integrally provided with the mixing joint.

According to the sixth aspect of the present invention, since the first part and the second part are integrally provided with the mixing joint, there is no need to connect a heat storage part to the mixing joint as a separate body, and it is possible to simplify manufacturing steps.

A seventh aspect of the present invention is the blow-by gas treatment device according to any one of the first to sixth aspects of the present invention, wherein the heat storage portion is in contact with at least half of a circumference of the outer surface of the sub pipe in an extension direction of the sub pipe.

According to the seventh aspect of the present invention, since the heat storage portion is provided to be in contact with at least half of the circumference of the outer surface of the sub pipe, it is possible to efficiently conduct the heat generated by the electric heater from the heat storage portion to the sub pipe.

An eighth aspect of the present invention is the blow-by gas treatment device according to any one of the first to seventh aspects of the present invention, the device further including a cooling water flow path through which cooling water of the engine is led and heat is conducted to the gas that flows through the sub pipe.

According to the eighth aspect of the present invention, the cooling water that passes through the cooling water flow path efficiently conducts heat to the gas that has been separated from the blow-by gas and passes through the sub pipe of the mixing joint, and the mixing joint is heated from both sides with the heat together with heat from the heating device, whereby it is possible to more reliably suppress the water vapor that is contained in the gas in the mixing joint being frozen or condensed.

A ninth aspect of the present invention is the blow-by gas treatment device according to the eighth aspect of the present invention, wherein the cooling water flow path is disposed at a position where a wind that is generated by a fan of the engine is avoided.

According to the ninth aspect of the present invention, the temperature of the cooling water that passes through the cooling water flow path being lowered by the wind that is generated by the fan of the engine is suppressed. Therefore, the cooling water that passes through the cooling water flow path efficiently conducts heat to the gas that has been separated from the blow-by gas and passes through the sub pipe of the mixing joint through a heat exchange member, and it is possible to more reliably suppress the water vapor that is contained in the gas in the mixing joint being frozen or condensed.

A tenth aspect of the present invention is the blow-by gas treatment device according to any one of the first to ninth aspects of the present invention, wherein the electric heater has a positive temperature coefficient (PTC) heater.

According to the tenth aspect of the present invention, a self-control of the temperature is performed by the positive temperature characteristics of the PTC heater, there is no need to provide a separate control portion for the electric heater, and it is possible to simplify the device configuration.

An eleventh aspect of the present invention is an engine including a blow-by gas treatment device treating a blow-by gas that is generated in the engine, wherein the blow-by gas treatment device includes a mixing joint having a main pipe into which a new intake is introduced and a sub pipe that introduces a gas, obtained by separating the blow-by gas into an oil and the gas, into the main pipe, and a heating device that t is provided in the sub pipe of the mixing joint, and wherein the heating device has a heat storage portion that is provided near a connection position connecting with the main pipe in the sub pipe and an electric heater that is provided in the heat storage portion.

According to the eleventh aspect of the present invention, since the heat storage portion is provided near the connection position connecting with the main pipe in the sub pipe, it is possible to store heat generated by the electric heater in the heat storage portion and to efficiently conduct the heat from the heat storage portion to the connection portion between the sub pipe and the main pipe. This heat makes it possible to more reliably suppress water vapor that is contained in a gas in the mixing joint being frozen or condensed.

### Advantageous Effects of Invention

According to the present invention, it is possible to provide a blow-by gas treatment device capable of more reliably suppressing water vapor that is contained in a gas separated from a blow-by gas being frozen or condensed and an engine including the blow-by gas treatment device.

### BRIEF DESCRIPTION OF DRAWINGS

FIG. 1 is a cross-sectional view showing an engine including a blow-by gas treatment device according to an embodiment of the present invention.

FIG. 2 is a cross-sectional view showing a structural example of the blow-by gas treatment device according to the present embodiment in an X-Z plane.

FIG. 3 is a perspective view of the engine including the blow-by gas treatment device according to the present embodiment seen from diagonally above.

FIG. 4 is a perspective view of the engine including the blow-by gas treatment device according to the present embodiment seen from diagonally above.

FIG. 5 is a perspective view showing a structural example of a blow-by gas mixing joint and a heating device of the present embodiment.

FIG. 6 is a perspective view showing a structural example of the blow-by gas mixing joint and the heating device of the present embodiment.

FIG. 7 is a perspective view showing a structural example of the blow-by gas mixing joint and the heating device of the present embodiment.

FIG. 8 is a cross-sectional view showing a structural example of the blow-by gas mixing joint of the present embodiment.

FIG. 9 is a perspective view showing a configurational example of a first different embodiment of the present invention.

FIG. 10 is a perspective view showing a configurational example of the first different embodiment of the present invention.

FIG. 11 is a schematic cross-sectional view showing a configurational example of a second different embodiment of the present invention.

### DESCRIPTION OF EMBODIMENTS

Hereinafter, embodiments of the present invention will be described with reference to the drawings.

The embodiments to be described below are specific suitable examples of the present invention, and a variety of technically preferable limitations are thus attached thereto. However, the scope of the present invention is not limited to these aspects unless the present invention is described to be particularly limited in the following description. In addition, in each of the drawings, the same components will be given the same reference sign and will not be described in detail as appropriate.

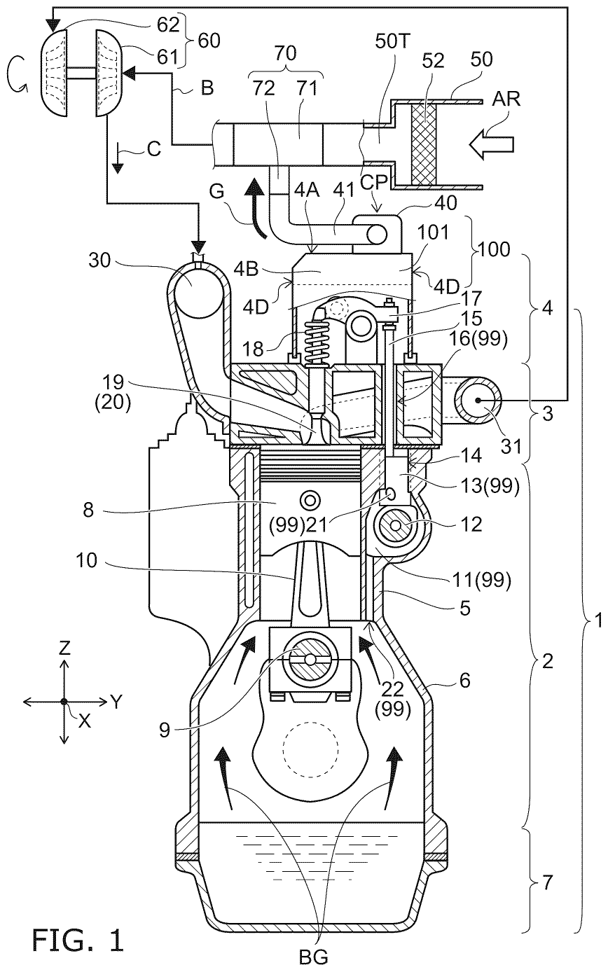

FIG. 1 is a cross-sectional view showing an engine including a blow-by gas treatment device according to an embodiment of the present invention.

An engine 1 shown in FIG. 1 is an internal combustion engine and is, for example, an industrial diesel engine. The engine 1 is, for example, a multi-cylinder engine such as a turbocharger-attached supercharged high-output three-cylinder engine or four-cylinder engine. The engine 1 is mounted in, for example, industrial machinery such as construction machinery or agricultural machinery. In addition, the engine 1 may configure a hybrid drive device by combining a charging power supply battery for driving and an electric motor for driving.

The engine 1 includes a cylinder block 2, a cylinder head 3, a head cover 4, an oil pan 7, and a blow-by gas treatment device 100. The cylinder head 3 is assembled on the cylinder block 2. The head cover 4 is assembled on the cylinder head 3. The cylinder block 2 has a cylinder 5 in the upper portion and a crankcase 6 in the lower portion. The oil pan 7 is disposed in the lower portion of the crankcase 6. A piston 8 is disposed in the cylinder 5. A crankshaft 9 is disposed to penetrate the crankcase 6. The piston 8 is coupled with the crankshaft 9 through a connecting rod 10.

As shown in FIG. 1, the cylinder 5 has a valve train cam chamber 11. A valve train cam shaft 12 is accommodated in the valve train cam chamber 11. A tappet 13 is vertically movable along a tappet guide hole 14. The lower portion of the tappet 13 is on the valve train cam shaft 12. A push rod 15 passes through an insertion hole 16. A rocker arm 17 is disposed in the head cover 4. The upper end portion of the push rod 15 abuts on the rocker arm 17.

The rocker arm 17 is biased toward the upper end portion of the push rod 15 by a spring 18. An intake valve 19 and an exhaust valve 20 vertically move by power conducted by the rotation of the valve train cam shaft 12 through the push rod 15 and the rocker arm 17 and open and close an intake port and an exhaust port, respectively.

As shown in FIG. 1, for example, an oil outflow hole 21 is provided in the tappet 13. An oil drop hole 22 is provided from the valve train cam chamber 11 through the crankcase 6. Therefore, the insertion hole 16, the inside of the tappet 13, the oil outflow hole 21, the valve train cam chamber 11, and the oil drop hole 22 configure an oil return channel 99. The oil return channel 99 is capable of returning an oil in the head cover 4 to the oil pan 7 through the inside of the crankcase 6. Each cylinder in the cylinder head 3 is connected to an intake passage 30 and an exhaust passage 31.

As shown in FIG. 1, there are cases where a blow-by gas BG is generated in any of a compression stroke and a combustion stroke of the engine 1. The blow-by gas BG is a gas that flows into the crankcase 6 through a gap between the piston 8 and the cylinder 5 shown in FIG. 1 and contains a mist of an unburned fuel component, a combusted gas component, an oil, or the like. The blow-by gas BG that has leaked into the crankcase 6 from the gap between the cylinder 5 and the piston 8 rises in the head cover 4 through, for example, the above-described oil return channel 99. That is, when leaking into the crankcase 6 from the gap between the cylinder 5 and the piston 8, the blow-by gas BG intrudes into the head cover 4 through, for example, the oil drop hole 22, the valve train cam chamber 11, the oil outflow hole 21 in the tappet 13, and the insertion hole 16 in the oil return channel 99 as a blow-by gas passage channel. The above-described oil return channel 99 is one example of the blow-by gas passage channel. The blow-by gas passage channel is not limited to the above-described oil return channel 99 alone.

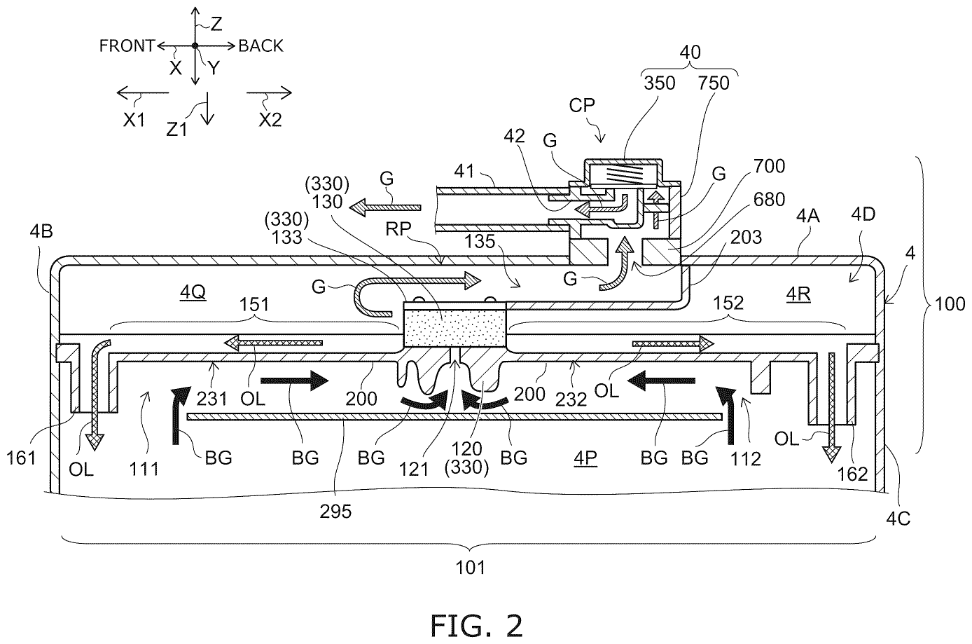

As shown in FIG. 1, the blow-by gas treatment device 100 is provided in the head cover 4. The blow-by gas treatment device 100 plays a role of separating the blow-by gas BG into an oil OL (refer to FIG. 2) and a gas (treated gas) G from which the mist of the oil OL has been separated (refer to FIG. 2). For example, the gas G that is contained in the blow-by gas BG is sent to a pipe 41 connected to an external intake system of the head cover 4 through the blow-by gas treatment device 100. The gas G that is contained in the blow-by gas BG is, for example, an unburned gas component or combusted gas component from which the oil OL and the mist of the oil OL have been removed from the blow-by gas BG. The oil (lubricant component) OL is collected into the oil pan 7 through, for example, the head cover 4, the inside of the cylinder head 3, and the oil return channel 99.

A connecting tube 50T in an intake pipe 50 shown in FIG. 1 and the pipe 41 are connected to each other through a blow-by gas mixing joint (one example of a mixing joint) 70. When a new intake AR is sucked into the intake pipe 50, the new intake AR passes through an air cleaner 52 and the connecting tube 50T and enters a main pipe 71 of the blow-by gas mixing joint 70. On the other hand, the gas G obtained by separating the oil OL from the blow-by gas BG with the blow-by gas treatment device 100 enters a sub pipe 72 of the blow-by gas mixing joint 70 from an outlet portion 40 of the blow-by gas treatment device 100 through the pipe 41. This makes the new intake AR and the gas G mixed together in the blow-by gas mixing joint 70 and turn into a sucked air B.

On the other hand, exhaust from the exhaust passage 31 is supplied to a turbine 62 of a turbocharger 60 and thereby rotates the turbine 62 and a compressor 61 at a high speed. The mixed sucked air B is supplied to and compressed in the compressor 61 of the turbocharger 60. A compressed sucked air C is supercharged into the intake passage 30 of the intake system.

Next, a structural example of the blow-by gas treatment device according to the present embodiment will be described with reference to drawings.

FIG. 2 is a cross-sectional view showing the structural example of the blow-by gas treatment device according to the present embodiment in an X-Z plane.

Here, an X direction shown in FIG. 1 and FIG. 2 is a front and back direction of the engine 1 shown in FIG. 1, that is, the width direction of the crankshaft 9. An Y direction is the right and left direction of the engine 1. A Z direction is the up and down direction of the engine 1. The X, Y, and Z directions are orthogonal to one another.

As shown in FIG. 1 and FIG. 2, the blow-by gas treatment device 100 is also referred to as a breather device or a breather and has a main structure portion 101, the outlet portion 40, and the blow-by gas mixing joint 70. The main structure portion 101 is disposed in the head cover 4. The outlet portion 40 and the blow-by gas mixing joint 70 are provided to be exposed to the outside of the head cover 4. The main structure portion 101 is capable of separating the blow-by gas BG into the oil OL and the gas G and guiding the oil OL and the gas G with separate channels.

As shown in FIG. 2, the main structure portion 101 is provided in the head cover 4. The outlet portion 40 is provided to protrude upward from the head cover 4. Furthermore, the outlet portion 40 is disposed at, for example, a substantially central position CP in the front and back direction, which is the X direction, of the main structure portion 101 as shown in FIG. 2. A detailed structural example of the outlet portion 40 will be described after a detailed structural example of the main structure portion 101 is described.

First, the structural example of the main structure portion 101 of the blow-by gas treatment device 100 will be described with reference to FIG. 1 and FIG. 2.

As shown in FIG. 1 and FIG. 2, the main structure portion 101 is accommodated in the head cover 4. Specifically, the head cover 4 has an upper surface portion 4A, a front surface portion 4B, a back surface portion 4C, and right and left surface portions 4D. The main structure portion 101 is disposed in a space surrounded by the upper surface portion 4A, the front surface portion 4B, the back surface portion 4C, and the right and left surface portions 4D. As shown in FIG. 2, the main structure portion 101 incorporates and guides the blow-by gas BG and separates the oil OL and the gas G that are contained in the blow-by gas BG from the blow-by gas BG. In addition, the main structure portion 101 guides the oil OL and the gas G with separate channels to prevent the oil OL and the gas G separated from the blow-by gas BG from leaking to the outside of the engine 1. In order for that, the head cover 4 is held in the cylinder head 3 in a state where the inside of the head cover 4 remains airtight with respect to the outside of the head cover 4. This makes the blow-by gas BG and the oil OL and the gas G separated from the blow-by gas BG kept from leaking to the outside of the engine 1.

As shown in FIG. 2, the main structure portion 101 schematically has a first blow-by gas incorporation portion 111, a second blow-by gas incorporation portion 112, a separation portion 330, a first oil guide groove portion 151, a second oil guide groove portion 152, a first oil drain 161, and a second oil drain 162. The first oil guide groove portion 151 and the second oil guide groove portion 152 are each one example of “oil guide portion.” The first oil drain 161 and the second oil drain 162 are each one example of “oil drain.”

The main structure portion 101 has a partition wall portion 200, a guide wall portion 203, and a guide plate 295 to configure the above-described components as shown in FIG. 2. The partition wall portion 200 is disposed in an X-Y plane, that is, horizontally, in the head cover 4, and partitions a lower portion region 4P and upper portion regions 4Q and 4R of the head cover 4. Therefore, the lower portion region 4P and the upper portion regions 40 and 4R form independent spaces from each other.

As shown in FIG. 2, the guide wall portion 203 reliably guides only the treated gas G, that is, the gas G obtained by separating the mist of the oil OL from the blow-by gas BG, to the outlet portion 40. The guide wall portion 203 is disposed between the partition wall portion 200 and the upper surface portion 4A of the head cover 4 and partitions the upper portion region 40 and the upper portion region 4R. The upper portion region 40 and the upper portion region 4R are independent spaces from each other.

Next, the first blow-by gas incorporation portion 111 and the second blow-by gas incorporation portion 112 will be described with reference to FIG. 2.

The first blow-by gas incorporation portion 111 and the second blow-by gas incorporation portion 112 are holes formed by the partition wall portion 200 and the guide plate 295 and incorporate the blow-by gas BG. The partition wall portion 200 is divided into a first guide lower surface portion 231 side and a second guide lower surface portion 232 side across the separation portion 330 as the center. The first blow-by gas incorporation portion 111 is provided at a position closer to the front surface portion 4B (that is, on the front side of the engine 1) and incorporates the blow-by gas BG from the front side. In addition, the second blow-by gas incorporation portion 112 is provided at a position closer to the back surface portion 4C (that is, on the back side of the engine 1) and incorporates the blow-by gas BG from the back side.

The guide plate 295 shown in FIG. 2 has a portion separated from the partition wall portion 200 to face the first guide lower surface portion 231 and the second guide lower surface portion 232 and is disposed along the X-Y plane.

As shown in FIG. 1, when the blow-by gas BG that has risen in the crankcase 6 reaches the lower portion region 4P of the head cover 4 shown in FIG. 2, the blow-by gas BG passes through the first blow-by gas incorporation portion 111, is incorporated between the first guide lower surface portion 231 of the partition wall portion 200 and the guide plate 295, and is guided toward the separation portion 330. Alternatively, the blow-by gas BG passes through the second blow-by gas incorporation portion 112, is incorporated between the second guide lower surface portion 232 and the guide plate 295, and is guided toward the separation portion 330. In addition, the blow-by gas BG reaches an impactor 120 of the separation portion 330 that is present at a central position RP in the X direction, which is the front and back direction, like arrows shown in FIG. 2.

Next, the separation portion 330 will be described with reference to FIG. 2.

The separation portion 330 shown in FIG. 2 is also referred to as an impactor-type separator, has the impactor 120, a filter 130, and a collision plate 133, and is provided between the first blow-by gas incorporation portion 111 and the second blow-by gas incorporation portion 112 in the front and back direction of the engine 1. More specifically, the separation portion 330 is provided at the central portion between the first oil drain 161 and the second oil drain 162 in the front and back direction of the engine 1, that is, at the central position RP.

The impactor 120 has a function of a nozzle or an orifice. The axial direction of a diaphragm hole 121 in the impactor 120 is along the vertical direction or the up and down direction, which is the Z direction, that is, a vertical diaphragm hole. The impactor 120 is a flow rate increase operation portion capable of increasing the flow rate of the blow-by gas BG by passing the blow-by gas BG upward along the diaphragm hole 121. The impactor 120 is disposed at the central position RP in the X direction of the partition wall portion 200. This makes the blow-by gas BG that is incorporated by the first blow-by gas incorporation portion 111 and the blow-by gas BG that is incorporated by the second blow-by gas incorporation portion 112 equally guided to the impactor 120. The impactor 120 increases the flow rate of the blow-by gas BG that flows through the diaphragm hole 121 and then leads the blow-by gas BG to the filter 130.

As shown in FIG. 2, the filter 130 is replaceably installed on the partition wall portion 200. The filter 130 is a member for improving the performance of separating the oil OL from the blow-by gas BG (that is, the oil OL separation performance) and is made of a material, for example, glass wool or steel wool. However, the material of the filter 130 is not particularly limited. The filter 130 is disposed between the collision plate 133 and the impactor 120. That is, the filter 130 has the impactor 120 as the flow rate increase operation portion disposed on the lower surface thereof. The filter 130 has the collision plate 133 disposed on the upper surface thereof.

The collision plate 133 is, for example, a metal plate and extends in the horizontal direction. The collision plate 133 separates the blow-by gas BG into the oil OL and the gas G that does not contain the mist of the oil OL by causing the blow-by gas BG to collide with the collision plate 133 at an increased flow rate through the filter 130. The blow-by gas BG that flows at an increased flow rate is caused to collide with the collision plate 133 while a foreign matter is removed through the filter 130 and is thereby separated into the oil OL and the gas G that does not contain the mist of the oil OL. In addition, the gas G separated from the blow-by gas BG with the separation portion 330 is discharged from the filter 130.

As described above, the guide wall portion 203 is provided between the partition wall portion 200 and the upper surface portion 4A of the head cover 4. Therefore, the gas G that does not contain the mist of the oil OL discharged from the filter 130 is guided with the guide wall portion 203, passes through a passage 135 in the upper portion region 4Q, and is led to the outlet portion 40. The guide wall portion 203 is disposed in the head cover 4 and is thereby capable of guiding the gas G separated with the separation portion 330 to the outlet portion 40.

On the other hand, the oil OL separated from the blow-by gas BG with the separation portion 330 passes through the filter 130, falls down, and drops on the upper surface of the impactor 120. The oil OL that has dropped on the upper surface of the impactor 120 flows along the upper surface of the impactor 120 and flows toward the first oil guide groove portion 151 and the second oil guide groove portion 152.

The separation portion 330 is positioned at the central position RP in the X direction shown in FIG. 2 and plays a role of a gathering portion capable of gathering the blow-by gas BG toward the central portion in the X direction from the front side and the back side of the engine 1. The separation portion 330 is present at the central position RP in the X direction of the head cover 4 as described above and is thus capable of gathering the blow-by gas BG to the central portion from the front side and the back side in the X direction in the head cover 4 and separating the blow-by gas BG into the oil OL and the gas G that does not contain the mist of the oil OL.

Next, the first oil guide groove portion 151 and the second oil guide groove portion 152 will be described with reference to FIG. 2.

The first oil guide groove portion 151 shown in FIG. 2 exhibits a groove shape, is provided from the front surface portion 4B of the head cover 4 up to the vicinity of the filter 130 and is inclined downward from the filter 130 toward the front surface portion 4B of the head cover 4. Similarly, the second oil guide groove portion 152 exhibits a groove shape, is provided from the back surface portion 4C of the head cover 4 up to the vicinity of the filter 130 and is inclined downward from the filter 130 toward the back surface portion 4C of the head cover 4. The first oil guide groove portion 151 and the second oil guide groove portion 152 guide the oil OL separated from the blow-by gas BG with the separation portion 330. The first oil guide groove portion 151 is a specific structural example of “first oil guide portion” and is capable of guiding the oil OL that is discharged from the filter 130 forward in an X1 direction when the engine 1 of FIG. 1 is inclined forward and leading the oil OL to the first oil drain 161 on the front side. Similarly, the second oil guide groove portion 152 is a specific structural example of “second oil guide portion” and is capable of guiding the oil OL that is discharged from the filter 130 backward in an X2 direction when the engine 1 of FIG. 1 is inclined backward and leading the oil OL to the second oil drain 162 on the back side.

The first oil guide groove portion 151 and the second oil guide groove portion 152 may be connected to each other. In this case, in one oil guide groove portion, a part provided toward the front side of the engine 1 from the filter 130 is referred to as the first oil guide groove portion 151, and a part provided toward the back side of the engine 1 from the filter 130 is referred to as the second oil guide groove portion 152.

Next, the first oil drain 161 and the second oil drain 162 will be described with reference to FIG. 2.

The first oil drain 161 is provided on the front side of the engine 1 and exhibits, for example, a tubular shape. The first oil drain 161 is provided downward, which is a Z1 direction, in the head cover 4 at a front position of the first guide lower surface portion 231 of the partition wall portion 200. The first oil drain 161 has a check valve, temporarily stores the oil OL guided by the first oil guide groove portion 151, and discharges the oil OL into the engine 1. Similarly, the second oil drain 162 is provided on the back side of the engine 1 and exhibits, for example, a tubular shape. The second oil drain 162 is provided downward, which is the Z1 direction, in the head cover 4 at a back position of the second guide lower surface portion 232 of the partition wall portion 200. The second oil drain 162 has a check valve, temporarily stores the oil OL guided by the second oil guide groove portion 152, and discharges the oil OL into the engine 1.

Therefore, when the engine 1 is inclined forward, the oil OL separated from the blow-by gas BG with the separation portion 330 is guided in the X1 direction by the first oil guide groove portion 151, temporarily stored in the first oil drain 161, and discharged in the Z1 direction through the first oil drain 161. Similarly, when the engine 1 is inclined backward, the oil OL separated from the blow-by gas BG with the separation portion 330 is guided in the X2 direction by the second oil guide groove portion 152, temporarily stored in the second oil drain 162, and discharged in the Z1 direction through the second oil drain 162. In the head cover 4, the oil OL discharged from the first oil drain 161 and the second oil drain 162 is collected into the oil pan 7 from, for example, the head cover 4 shown in FIG. 1 through the above-described oil return channel 99. Alternatively, it is also possible to collect the discharged oil OL into, for example, an oil container, not shown. This makes the oil OL that is discharged from the first oil drain 161 and the second oil drain 162 discharged into the engine 1 and prevents the oil OL from leaking to the outside of the engine 1.

Next, a structural example of the outlet portion 40 of the blow-by gas treatment device 100 will be described with reference to FIG. 2

As described already, the outlet portion 40 shown in FIG. 2 is provided to protrude in the Z direction from the head cover 4. Specifically, the outlet portion 40 is provided to protrude outward from the upper surface portion 4A of the head cover 4. The outlet portion 40 is disposed at, for example, the substantially central position CP in the front and back direction, which is the X direction, of the main structure portion 101 of The outlet portion 40 has a pressure regulating valve (diaphragm) 350 and a container body 750 as shown in FIG. 2 and adjusts the pressure of the gas G at, for example, the substantially central position CP of the engine 1 to send only the gas G led from the main structure portion 101 to the pipe 41 of the intake system of the engine 1. That is, the outlet portion 40 is capable of returning the gas G separated from the blow-by gas BG with the separation portion 330 to the intake system of the engine 1 through the pipe 41 and combusting the gas G again. This makes it possible to improve the environmental performance of the engine 1 by preventing the gas G separated from the blow-by gas BG from being discharged to the outside of the engine 1.

The pressure regulating valve 350 suppresses the inflow of the new intake AR into the engine 1 through the blow-by gas mixing joint 70 and the pipe 41 of the intake system while adjusting the pressure between the inside of the engine 1 and the intake system of the engine 1 (refer to FIG. 1).

As shown in FIG. 2, the container body 750 is indirectly fixed to the upper surface portion 4A of the head cover 4 through an outlet installation portion 700 and holds the pressure regulating valve 350. The container body 750 may be directly fixed to the upper surface portion 4A of the head cover 4 without the outlet installation portion 700. Alternatively, the outlet installation portion 700 may be a part of the head cover 4 or is formed around a through hole for gas discharge 680 provided in the head cover 4 to rise toward the outside from the upper surface portion 4A of the head cover 4.

The through hole for gas discharge 680 is provided in a circular shape to penetrate the upper surface portion 4A of the head cover 4 along the Z direction. That is, the central axis of the through hole for gas discharge 680 is along the Z direction. The through hole 680 allows the gas G separated from the blow-by gas BG with the separation portion 330 to pass through.

The container body 750 is also referred to as a spacer or the like and is installed on the outlet installation portion 700. The container body 750 is capable of temporarily storing the gas G that comes up from the inside of the head cover 4 through the through hole 680 of the outlet installation portion 700 and supplying the gas G to the intake system side of the engine 1 shown in FIG. 1 through the pipe 41. The container body 750 has a gas flow path 42. The gas flow path 42 passes through the through hole 680 and leads the gas G that has further passed through the pressure regulating valve 350 to the intake system of the engine 1 through the pipe 41.

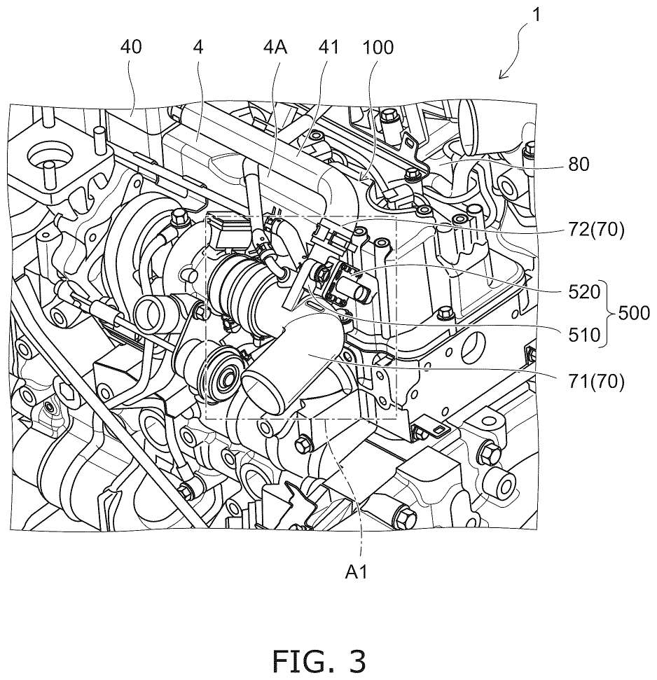

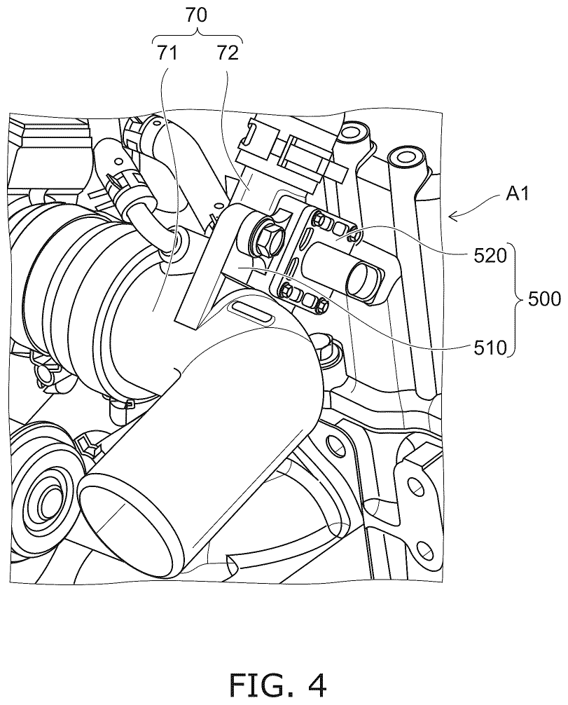

Next, a structural example of the engine 1 and the blow-by gas treatment device 100 according to the present embodiment will be described in detail with reference to FIG. 3. FIG. 3 and FIG. 4 are perspective views of the engine including the blow-by gas treatment device according to the present embodiment seen from diagonally above.

FIG. 4 shows a part Al of the engine 1 shown in FIG. 3 in an enlarged manner.

As shown in FIG. 3 and FIG. 4, the outlet portion 40, the blow-by gas mixing joint 70, and a heating device 500 of the blow-by gas treatment device 100 are provided outside the head cover 4 of the engine 1. The outlet portion 40 of the blow-by gas treatment device 100 protrudes outward from and is fixed to the upper surface portion 4A of the head cover 4.

As shown in FIG. 3 and FIG. 4, the heating device 500 is provided in the sub pipe 72 of the blow-by gas mixing joint 70. The heating device 500 has a heat storage portion 510 that is provided near a connection position connecting with the main pipe 71 in the sub pipe 72 and an electric heater 520 that is provided in the heat storage portion 510. The heat storage portion 510 plays a role of storing heat generated by the electric heater 520 and efficiently conducting the heat to the connection position between the sub pipe 72 and the main pipe 71. The heat storage portion 510 may be integrally provided with the blow-by gas mixing joint 70. Therefore, there is no need to connect the heat storage portion 510 to the blow-by gas mixing joint 70 as a separate body, and the heat storage portion 510 and the blow-by gas mixing joint 70 are formed of the same material, which makes it possible to continuously transmit heat from the heat storage portion 510 up to the blow-by gas mixing joint 70.

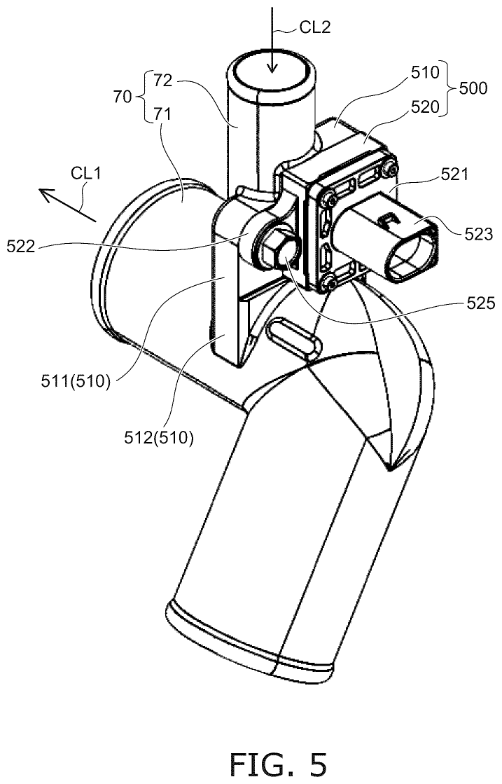

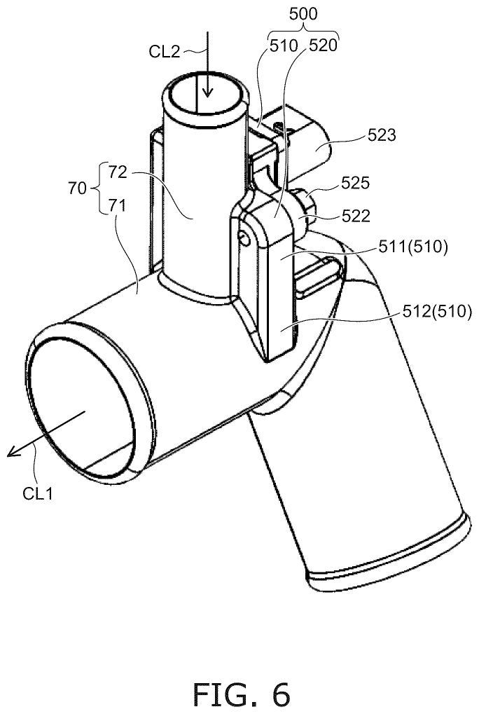

FIG. 5 and FIG. 6 are perspective views showing a structural example of the blow-by gas mixing joint and the heating device of the present embodiment. FIG. 5 shows a perspective view seen from a side of the heating device 500, and FIG. 6 shows a perspective view seen from a side opposite to the heating device 500.

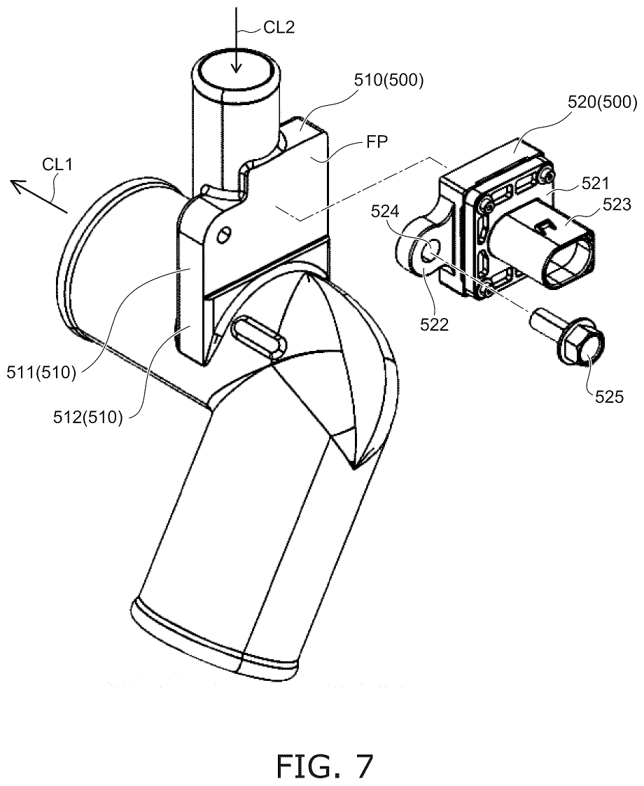

FIG. 7 is an exploded perspective view showing the structural example of the blow-by gas mixing joint and the heating device of the present embodiment.

An axial direction CL1 of the main pipe 71 of the blow-by gas mixing joint 70 is orthogonal to an axial direction CL2 of the sub pipe 72. The heat storage portion 510 of the heating device 500 has a first part 511 that is in contact with the outer surface of the sub pipe 72 and a second part 512 that extends from the first part 511 up to the outer surface of the main pipe 71. The first part 511 as the heat storage portion 510 may be provided to be in contact with at least half of the circumference of the outer surface of the sub pipe 72 when seen in the extension direction (axial direction CL2) of the sub pipe 72. In addition, the second part 512 that extends from the first part 511 may be provided to be in contact with at least half of the circumference of the outer surface of the main pipe 71 when seen in the extension direction (axial direction CL1) of the main pipe 71. That is, the heat storage portion 510 is provided to be wrapped by halves of the circumferences of the outer surfaces of the main pipe 71 and the sub pipe 72, respectively, at the connection position between the main pipe 71 and the sub pipe 72 of the blow-by gas mixing joint 70.

In addition, as shown in FIG. 7, a flat first surface FP is provided in the first part 511 of the heat storage portion 510, and the electric heater 520 is installed on this first surface FP. The electric heater 520 has a chassis 521 where a heating element is accommodated, an installation piece 522 that extends from the chassis 521, and a connector connection portion 523 for connecting a connector that supplies power (not shown) to the heating element. The electric heater 520 is fastened to the first surface FP by, for example, passing a bolt 525 through a hole 524 provided in the installation piece 522. This makes the electric heater 520 surface-connected to the flat first surface FP of the first part 511, whereby it is possible to stably fix the electric heater 520 and to efficiently conduct heat generated by the electric heater 520 to the first part 511.

The electric heater 520 preferably has a positive temperature coefficient (PTC) heater. The PTC heater has positive temperature characteristics, and a self-control of the temperature is thus performed. This eliminates a need to provide a separate control portion for the electric heater 520 and makes it possible to simplify the device configuration. The PTC heater is accommodated in the chassis 521 and receives power through the connector (not shown) connected to the connector connection portion 523. The use of the electric heater 520 makes it possible to perform immediate heating by conducting electricity even when the engine is in a low-temperature state and rapidly suppresses freezing or condensation in the blow-by gas mixing joint 70.

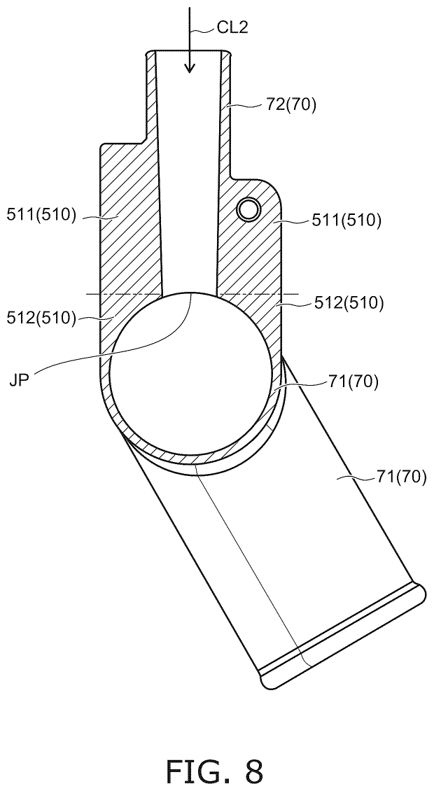

FIG. 8 is a cross-sectional view showing a structural example of the blow-by gas mixing joint of the present embodiment. FIG. 8 shows a cross-sectional view of the blow-by gas mixing joint cut in the extension direction at the central position of the sub pipe 72. The heat storage portion 510 is provided to project toward both sides from the sub pipe 72 at near the connecting part of the sub pipe 72 with the main pipe 71 in the blow-by gas mixing joint 70 and extends up to the main pipe 71. In the heat storage portion 510, a part toward the sub pipe 72 from a connection position JP between the sub pipe 72 and the main pipe 71 is the first part 511, and a part toward the main pipe 71 is the second part 512.

The electric heater 520 is installed in such a heat storage portion 510, whereby it is possible to conduct and store the heat generated by the electric heater 520 to and in the heat storage portion 510 and to transmit the heat from the sub pipe 72 through the main pipe 71. That is, when the heat storage portion 510 is provided, the heat capacity increases, and it becomes easy to maintain an appropriate temperature at the time of heating the main pipe 71 or the sub pipe 72 compared with a case where the main pipe 71 or the sub pipe 72 is directly heated.

### Description of Freezing or Condensation Prevention Treatment of Gas G Flowing in Sub Pipe 72 of Blow-By Gas Mixing Joint 70

Next, a freezing or condensation prevention treatment of the gas G that flows in the sub pipe 72 of the blow-by gas mixing joint 70 will be described.

First, the flow of the gas G separated from the blow-by gas BG with the separation portion 330 shown in FIG. 2 will be described. The gas G separated from the blow-by gas BG with the separation portion 330 shown in FIG. 2 passes through the through hole 680 in the outlet installation portion 700, and the gas G that has passed through the through hole 680 is led to the pressure regulating valve 350. In addition, when the pressure in the engine 1 increases to a predetermined pressure or higher or the pressure of the intake system of the engine 1 decreases to lower than a predetermined pressure, the pressure regulating valve 350 opens. In such a case, the gas G led to the pressure regulating valve 350 is led to the intake system of the engine 1 through the pipe 41.

Here, the blow-by gas mixing joint 70 of the blow-by gas treatment device 100 is provided to protrude outward on the upper surface portion 4A of the head cover 4 as shown in FIG. 3. Incidentally, the blow-by gas BG and the gas G separated from the blow-by gas BG contain water vapor. Therefore, when the engine 1 is in a low-temperature state, the water vapor that is contained in the gas G is frozen or condensed in the blow-by gas mixing joint 70, whereby there is a concern that the sub pipe 72 may be blocked. In such a case, there is a concern that the pipe 41 from the outlet portion 40 of the blow-by gas treatment device through the intake system of the engine and a gas channel that reaches the blow-by gas mixing joint 70 may be blocked. When the gas channel is blocked, the internal pressure of the engine increases, and there is a concern that, for example, an oil seal provided in a crankcase may be damaged or rolled up and oil leakage may occur. In addition, when the gas channel is blocked, the internal pressure of the engine increases, and there is a concern that an oil gauge may fall out from an oil gauge guide and oil leakage may occur. Furthermore, when the gas channel is blocked, the internal pressure of the engine increases, and there is a concern that a turbocharger may absorb oil from the inside of the head cover.

In order to prevent such blocking of the gas channel, in the blow-by gas treatment device 100 according to the present embodiment and the engine 1 including the blow-by gas treatment device 100, an effort shown in FIG. 3 has been implemented. That is, heat is generated by the electric heater 520 in the heating device 500, and this heat is stored in the heat storage portion 510 and transmitted to the sub pipe 72 and the main pipe 71. When electricity is conducted to the electric heater 520 at the time of starting the engine 1, it is possible to increase the temperature of the gas G that flows in the sub pipe 72 even before the warm-up operation of the engine 1 is completed by conducting heat to the gas G that flows in the sub pipe 72.

The heat storage portion 510 has the first part 511 that is in contact with the outer surface of the sub pipe 72 and the second part 512 that extends from the first part 511 up to the outer surface of the main pipe 71 as shown in FIG. 5 and FIG. 6, and it is thus possible to conduct heat that has been generated by the heating device 500 and stored in the heat storage portion 510 to the sub pipe 72 with the first part 511 and to the main pipe 71 with the second part 512. This makes it possible to efficiently heat the connecting part between the sub pipe 72 and the main pipe 71 in the blow-by gas mixing joint 70.

Furthermore, the first part 511 as the heat storage portion 510 is in contact with at least half of the circumference of the outer surface of the sub pipe 72, and the second part 512 is in contact with at least half of the circumference of the outer surface of the main pipe 71, whereby it is possible to conduct heat from the heat storage portion 510 to a wide range in the connecting part between the sub pipe 72 and the main pipe 71. In addition, the configuration in which heat is stored in the heat storage portion 510 and the heat is conducted to the sub pipe 72 and the main pipe 71 and the configuration in which the PTC heater is included as the electric heater 520 make it possible to stably conduct heat at a temperature self-controlled with the PTC heater.

### First Different Embodiment of Present Invention

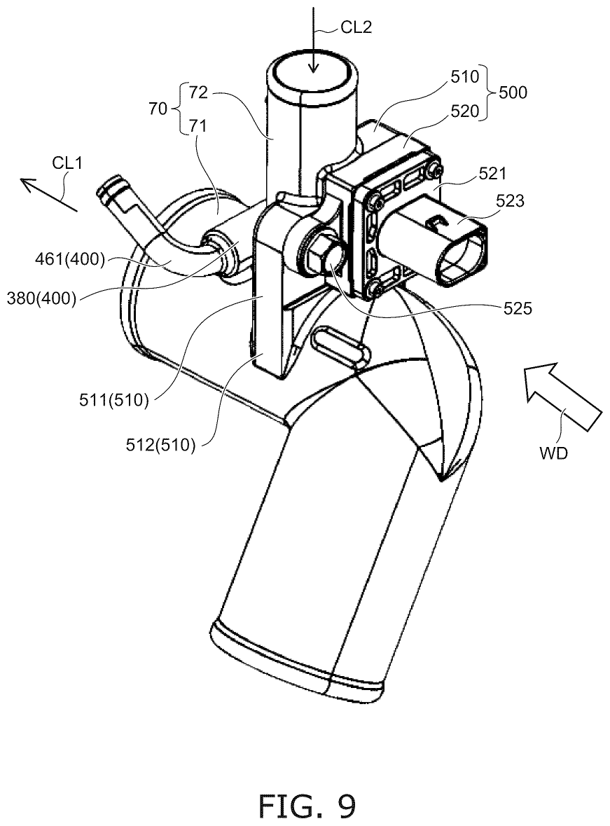

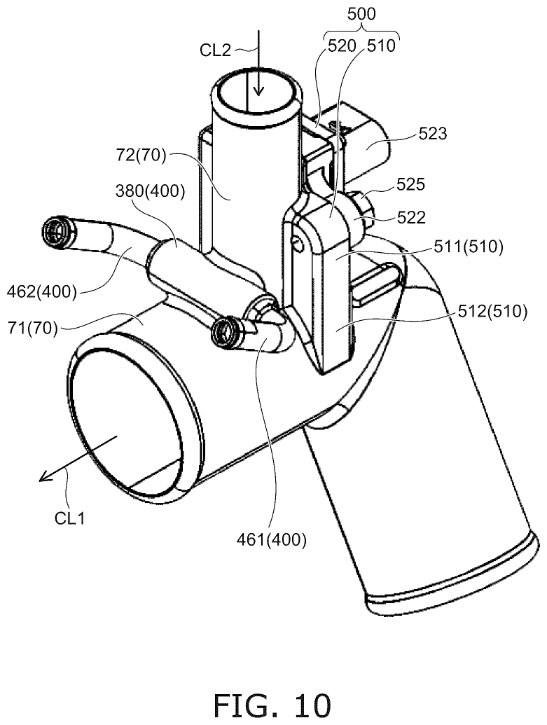

FIG. 9 and FIG. 10 are perspective view showing a configurational example of a first different embodiment of the present invention. FIG. 9 shows a perspective view seen from a side of the heating device 500, and FIG. 10 shows a perspective view seen from a side opposite to the heating device 500.

As shown in FIG. 9 and FIG. 10, the first different embodiment of the present invention is a configuration in which a cooling water flow path 400 that leads cooling water of the engine 1 is further provided. The cooling water flow path 400 is provided on a side opposite to the heating device 500 on the sub pipe 72. That is, the heating device 500 is provided on one side of the outer surface of the sub pipe 72, and the cooling water flow path 400 is provided on the other side.

The cooling water flow path 400 is, for example, a metal pipe having a circular cross-sectional shape for passing the cooling water through. The cooling water flow path 400 has an upstream side channel 461, a downstream side channel 462, and a heat exchange member 380. One end portion of the upstream side channel 461 of the cooling water flow path 400 is connected to an exhaust gas recirculation device 80 (refer to FIG. 3).

The exhaust gas recirculation device 80 has an EGR cooler and an EGR valve and recirculates a part of exhaust that flows in the intake system of the engine 1 as an exhaust recirculation gas to the intake system of the engine 1. Specifically, one end portion of the upstream side channel 461 is connected to a water jacket (not shown) provided in the EGR valve of the exhaust gas recirculation device 80, draws out a part of the cooling water that flows in the water jacket of the EGR valve, and leads the cooling water to the other end portion of the upstream side channel 461. The cooling water being used is, for example, a long life coolant (LLC) that cools the cylinder block 2 and the cylinder head 3, which are shown in FIG. 2, and the like and reaches a temperature of approximately 70 °C to 80 °C when the warm-up operation of the engine 1 has been completed.

As shown in FIG. 9 and FIG. 10, the other end portion of the upstream side channel 461 is connected to one end portion of the heat exchange member 380. The heat exchange member 380 is, for example, a tubular metal member and is provided as a linear member. The heat exchange member 380 is provided to form a mechanically and thermally integral structure with the sub pipe 72 of the blow-by gas mixing joint 70.

When such a cooling water flow path 400 is provided, the heat of the cooling water that passes through the cooling water flow path 400 can be efficiently conducted to the gas G that passes through the sub pipe 72 of the blow-by gas mixing joint 70. This makes it possible to heat the blow-by gas mixing joint 70 from both sides with the heat of the cooling water that flow through the cooling water flow path 400 together with heat from the heating device 500 and makes it possible to more reliably prevent the freezing or condensation of the water vapor that is contained in the gas G at low temperatures.

Here, the engine 1 includes a suction-type cooling fan (one example of a fan) on the front portion side of the engine 1. When the engine 1 operates, the cooling fan generates a cooling air WD toward the back of the engine 1 to cool the engine 1. If the cooling air WD generated by the cooling fan cools the warmed cooling water that passes through the upstream side channel 461, it becomes difficult for the cooling water to warm the gas G that passes through the inside of the sub pipe 72 of the blow-by gas mixing joint 70 through the heat exchange member 380. Therefore, there is a concern that it may be impossible to reliably suppress the water vapor that is contained in the gas G being frozen or condensed in the blow-by gas mixing joint 70.

Therefore, in the present embodiment, the cooling water flow path 400 is disposed at a position at which the air that is generated by the cooling fan of the engine 1 is avoided to prevent the cooling water that passes through the cooling water flow path 400 from being cooled by the cooling air WD from the cooling fan. Specifically, a disposition shape example of the upstream side channel 461 is devised as described below. The upstream side channel 461 is disposed at a position at which the cooling air WD that is generated by the cooling fan is avoided near a region from the outlet portion 40 through the heat exchange member 380. For example, the upstream side channel 461 is disposed on the downstream side of the cooling air WD with respect to a different part (for example, the heating device 500) so that the cooling air WD from the cooling fan does not directly hit the upstream side channel 461.

This prevents the cooling air WD from directly hitting the upstream side channel 461 and suppresses the warmed cooling water that passes through the upstream side channel 461 being cooled by the cooling air WD. That is, it is possible to prevent the temperature of cooling water from being decreased by the cooling air WD by suppressing the occurrence of a phenomenon in which the cooling air WD cools the warmed cooling water that passes through the upstream side channel 461. In addition, the cooling water is capable of efficiently warming the gas G that passes through the inside of the sub pipe 72 of the blow-by gas mixing joint 70 through the heat exchange member 380, and it is possible to more reliably suppress the water vapor that is contained in the gas G being frozen or condensed in the blow-by gas mixing joint 70.

Furthermore, the heat exchange member 380 itself in the cooling water flow path 400 is disposed at a position at which the cooling air WD that is generated by the cooling fan is avoided near the sub pipe 72 of the blow-by gas mixing joint 70. Specifically, the heat exchange member 380 is disposed on the back side of the sub pipe 72, that is, disposed on the downstream side of the cooling air WD with respect to the sub pipe 72. Therefore, the flow of the cooling air WD is blocked by the sub pipe 72. In addition, the cooling air WD directly hitting the heat exchange member 380 is prevented. This makes it possible for the cooling water to efficiently warm the gas G that passes through the inside of the sub pipe 72 of the blow-by gas mixing joint 70 through the heat exchange member 380 and makes it possible to more reliably suppress the water vapor that is contained in the gas G being frozen or condensed in the blow-by gas mixing joint 70.

### Second Different Embodiment of Present Invention

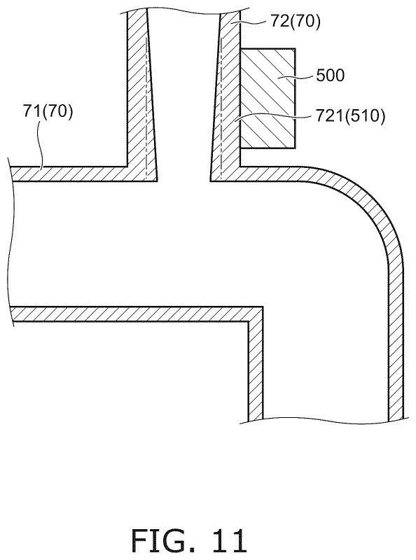

FIG. 11 is a schematic cross-sectional view showing a configurational example of a second different embodiment of the present invention.

As shown in FIG. 11, the second different embodiment of the present invention is a configuration in which at least a part of a thickness gradual increase part 721 provided in the sub pipe 72 is used as the heat storage portion 510. That is, the sub pipe 72 has the gradual increase part 721 that gradually increases in thickness from a far position toward a close position to the connection position. The gradual increase part 721 may be a part in which the thickness of the sub pipe 72 increases in a tapered shape or a part in which the thickness of the sub pipe 72 increases stepwise. FIG. 11 shows an example where the thickness of the sub pipe 72 increases in a tapered shape. The heat storage portion 510 includes at least a part of this gradual increase part 721. The electric heater 520 is installed on the outside of the gradual increase part 721 of the sub pipe 72.

According to the present embodiment, since at least a part of the thickness gradual increase part 721 in the sub pipe 72 is used as the heat storage portion 510, it is possible to store heat from the electric heater 520 in the gradual increase part 721 and efficiently conduct the heat to the connection position between the sub pipe 72 and the main pipe 71. In addition, since the gradual increase part 721 is a part in which the thickness gradually increases toward the inside of the tube in the sub pipe 72, there is only a small part being exposed to the outside of the heat storage portion 510, and the gradual increase part 721 is thus less likely to be affected by heat dissipation due to an external air. Therefore, it is possible to efficiently conduct the stored heat to the gas G that flows in the sub pipe 72.

Hitherto, the embodiments of the present invention have been described. However, the present invention is not limited to the above-described embodiments and can be changed in a variety of manners without departing from the claims. The configurations of the above-described embodiments can be partially omitted or arbitrarily combined in a different manner from what has been described above.

### REFERENCE SIGNS LIST

1 Engine
2 Cylinder block
3 Cylinder head
4 Head cover
4A Upper surface portion
4B Front surface portion
4C Back surface portion
4D Right and left surface portions
4P Lower surface region
4Q Upper surface region
4R Upper surface region
5 Cylinder
6 Crankcase
7 Oil pan
8 Piston
9 Crankshaft
10 Connecting rod
11 Valve train cam chamber
12 Valve train cam shaft
13 Tappet
14 Tappet guide hole
15 Push rod
16 Insertion hole
17 Rocker arm
18 Spring
19 Intake valve
20 Exhaust valve
21 Oil outflow hole
22 Oil drop hole
30 Intake passage
31 Exhaust passage
40 Outlet portion
41 Pipe
42 Gas flow path
50 Intake pipe
50T Connecting tube
52 Air cleaner
60 Turbocharger
61 Compressor
62 Turbine
70 Blow-by gas mixing joint
71 Main pipe
72 Sub pipe
80 Exhaust gas recirculation device
99 Oil return channel
100 Blow-by gas treatment device
101 Main structure portion
111 First blow-by gas incorporation portion
112 Second blow-by gas incorporation portion
120 Impactor
121 Diaphragm hole
130 Filter
133 Collision plate
135 Passage
151 First oil guide groove portion
152 Second oil guide groove portion
161 First oil drain
162 Second oil drain
200 Partition wall portion
203 Guide wall portion
231 First guide lower surface portion
232 Second guide lower surface portion
295 Guide plate
330 Separation portion
350 Pressure regulating valve
380 Heat exchange member
400 Cooling water flow path
461 Upstream side channel
462 Downstream side channel
500 Heating device
510 Heat storage portion
511 First part
512 Second part
520 Electric heater
521 Chassis
522 Installation piece
523 Connector connection portion
524 Hole
525 Bolt
680 Through hole
700 Outlet installation portion
721 Gradual increase part
750 Container body
AR New intake
B Sucked air
BG Blow-by gas
C Sucked air
CL1 Axial direction
CL2 Axial direction
FP First surface
G Gas
JP Connection position
OL Oil
RP Central position
WD Cooling air

1. A blow-by gas treatment device treating a blow-by gas that is generated in an engine, the device comprising:
a mixing joint having a main pipe into which a new intake is introduced and a sub pipe that introduces a gas, obtained by separating the blow-by gas into an oil and the gas, into the main pipe; and
a heating device that is provided in the sub pipe of the mixing joint, wherein
the heating device has a heat storage portion that is provided near a connection position connecting with the main pipe in the sub pipe and an electric heater that is provided in the heat storage portion.

2. The blow-by gas treatment device according to claim 1, wherein
the sub pipe has a gradual increase part that gradually increases in thickness thereof from a far position toward a close position relative to the connection position, and
the heat storage portion includes at least a part of the gradual increase part.

3. The blow-by gas treatment device according to claim 1,
wherein the heat storage portion has a first part that is in contact with an outer surface of the sub pipe and a second part that extends from the first part up to an outer surface of the main pipe.

4. The blow-by gas treatment device according to claim 3,
wherein the second part is in contact with at least half of a circumference of the outer surface of the main pipe in an extension direction of the main pipe.

5. The blow-by gas treatment device according to claim 3, wherein
the first part has a flat first surface, and
the electric heater is installed on the first surface.

6. The blow-by gas treatment device according to claim 3,
wherein the first part and the second part are integrally provided with the mixing joint.

7. The blow-by gas treatment device according to claim 1,
wherein the heat storage portion is in contact with at least half of a circumference of the outer surface of the sub pipe in an extension direction of the sub pipe.

8. The blow-by gas treatment device according to claim 1, further comprising:
a cooling water flow path through which cooling water of the engine is led and heat is conducted to the gas that flows through the sub pipe.

9. The blow-by gas treatment device according to claim 8,
wherein the cooling water flow path is disposed at a position where a wind that is generated by a fan of the engine is avoided.

10. The blow-by gas treatment device according to claim 1,
wherein the electric heater has a positive temperature coefficient (PTC) heater.

11. An engine comprising a blow-by gas treatment device treating a blow-by gas that is generated in the engine, wherein
the blow-by gas treatment device includes
a mixing joint having a main pipe into which a new intake is introduced and a sub pipe that introduces a gas, obtained by separating the blow-by gas into an oil and the gas, into the main pipe, and
a heating device that is provided in the sub pipe of the mixing joint, and wherein
the heating device has a heat storage portion that is provided near a connection position connecting with the main pipe in the sub pipe and an electric heater that is provided in the heat storage portion.
